(19) United States
(12) Patent Application Publication
(10) Pub. No.: US 2025/0175025 A1
(43) Pub. Date: May 29, 2025

(54) CONTROLLING DISTRIBUTED ENERGY STORAGE SYSTEM

(71) Applicant: Elisa Oyj, Helsinki (FI)

(72) Inventors: Esko HEINONEN, Helsinki (FI); Simon HOLMBACKA, Helsinki (FI); Jukka-Pekka SALMENKAITA, Helsinki (FI)

(21) Appl. No.: 18/851,093

(22) PCT Filed: Mar. 16, 2023
(86) PCT No.: PCT/FI2023/050153

§ 371 Date: Sep. 26, 2024

(30) Foreign Application Priority Data
Mar. 31, 2022 (FI) 20225280

(51) Int. Cl. H02J 7/00; H02J 3/32

(52) U.S. Cl. CPC H02J 7/0071; H02J 3/32; H02J 2203/20

(57) ABSTRACT

A computer implemented method for controlling a virtual power plant, VPP, comprising a plurality of spatially distributed energy storage, DES, devices. The method is performed by operating the virtual power plant according to a first plan, wherein the first plan provides a pre-planned schedule for charging or discharging the DES devices over a first time period to fulfil a power reserve obligation; analysing the first plan in real time during the first time period, wherein the analysis is performed in view of predefined acceptance criteria and real time operating context data; and identifying a need to adjust the first plan on the basis of the analysis and accordingly adjusting the first plan in real time during the first time period.

### TECHNICAL FIELD

The present disclosure generally relates to controlling a distributed energy storage system. The present disclosure further relates to controlling a virtual power plant comprising distributed energy storage devices.

### BACKGROUND

This section illustrates useful background information without admission of any technique described herein representative of the state of the art.

A distributed energy storage (DES) system is a pool of battery resources controlled by a centralized control system. A DES system can be used for forming a virtual power plant (VPP) comprising a plurality of spatially distributed energy storage (DES) devices. In this way a larger capacity may be built by pooling together smaller scale resources. The DES devices may be resources maintained for example for emergency energy backup purposes, such as backup batteries of a wireless communication network. Additionally or alternatively, the DES devices may be resources owned by households or small and medium sized companies or other smaller scaler operators. As backup batteries are not constantly used, the resources can be used for further optimization purposes e.g. through the VPP.

Such VPPs may participate in balancing of electric grid or in intraday trading market. Transmission system operators (TSO) offer reserve markets where reserve providers, such as VPP, can offer energy capacity for grid balancing purposes. In order to participate in the grid balancing, the reserve provider needs to submit bids to the reserve market in advance, e.g. the day before (in Finland by 7.30 CET the previous day).

Now, there are provided some new considerations concerning controlling virtual power plant formed of a plurality of spatially distributed energy storage devices.

### SUMMARY

The appended claims define the scope of protection. Any examples and technical descriptions of apparatuses, products and/or methods in the description and/or drawings not covered by the claims are presented not as embodiments of the invention but as background art or examples useful for understanding the invention.

According to a first example aspect there is provided a computer implemented method for controlling a virtual power plant, VPP, comprising a plurality of spatially distributed energy storage, DES, devices. The method comprises
operating the virtual power plant according to a first plan, wherein the first plan provides a pre-planned schedule for charging or discharging the DES devices over a first time period to fulfil a power reserve obligation;
analysing the first plan in real time during the first time period, wherein the analysis is performed in view of predefined acceptance criteria and real time operating context data; and
identifying a need to adjust the first plan on the basis of the analysis and accordingly adjusting the first plan in real time during the first time period.

In some embodiments, the method further comprises
performing the analysis for a subperiod of the first time period;
identifying a need to adjust the first plan over the subperiod on the basis of the analysis and accordingly adjusting the first plan over the subperiod; and
continuing to analyse the following subperiod of the first time period, if any.

In some embodiments, the acceptance criteria is configured to provide one or more of: minimizing risk of failing to fulfil the power reserve obligation, minimizing risk of failing to fulfil a local energy source need, and identifying a possibility for further optimization of operation of the virtual power plant.

In some embodiments, the method further comprises responsive to determining existence of a risk of failing to fulfil the power reserve obligation or existence of a possibility for further optimization of operation of the virtual power plant, outputting an indication of a need to adjust the first plan.

In some embodiments, the method further comprises
determining if there is a risk of failing to fulfil the power reserve obligation;
responsive to determining existence of a risk of failing to fulfil the power reserve obligation, outputting an indication of a need to adjust the first plan;
responsive to determining no risk of failing to fulfil the power reserve obligation, determining if there is a possibility for further optimization of operation of the virtual power plant;
responsive to determining existence of a possibility for further optimization of operation of the virtual power plant, outputting an indication of a need to adjust the first plan;
responsive to determining no possibility for further optimization of operation of the virtual power plant, outputting an indication of no need to adjust the first plan.

In some embodiments, the analysing is performed in view of fulfilling the local energy source need.

In some embodiments, the operating context data comprises one or more of: DES infrastructure data, information about local energy source need, information about power reserve activations, information about electricity pricing.

In some embodiments, the DES infrastructure data comprises one or more of the following: power consumption, capacity, wear, and physical properties of the DES devices of the virtual power plant.

In some embodiments, adjusting the first plan comprises selecting an adjustment mechanism from a pool of adjustment mechanisms comprising one or more of: adjusting staggering of the DES devices, adjusting charging of the DES devices, adjusting usage of energy stored in the DES devices, participating in intraday trading market, transferring the power reserve obligation to a different entity, minimizing battery wear.

In some embodiments, the adjustment mechanisms of the pool are arranged in order of preference.

In some embodiments, one or more of the DES devices are co-located with an energy production unit.

In some embodiments, the DES devices comprise backup batteries of a wireless communication network.

In some embodiments, the DES devices comprise battery units of households or battery units of buildings.

According to a second example aspect of the present invention, there is provided an apparatus comprising a processor and a memory including computer program code; the memory and the computer program code configured to, with the processor, cause the apparatus to perform the method of the first aspect or any related embodiment.

According to a third example aspect of the present invention, there is provided a computer program comprising computer executable program code which when executed by a processor causes an apparatus to perform the method of the first aspect or any related embodiment.

According to a fourth example aspect there is provided a computer program product comprising a non-transitory computer readable medium having the computer program of the third example aspect stored thereon.

According to a fifth example aspect there is provided an apparatus comprising means for performing the method of any preceding aspect.

Any foregoing memory medium may comprise a digital data storage such as a data disc or diskette; optical storage; magnetic storage; holographic storage; opto-magnetic storage; phase-change memory; resistive random-access memory; magnetic random-access memory; solid-electrolyte memory; ferroelectric random-access memory; organic memory; or polymer memory. The memory medium may be formed into a device without other substantial functions than storing memory or it may be formed as part of a device with other functions, including but not limited to a memory of a computer; a chip set; and a sub assembly of an electronic device.

Different non-binding example aspects and embodiments have been illustrated in the foregoing. The embodiments in the foregoing are used merely to explain selected aspects or steps that may be utilized in different implementations. Some embodiments may be presented only with reference to certain example aspects. It should be appreciated that corresponding embodiments may apply to other example aspects as well.

### BRIEF DESCRIPTION OF THE FIGURES

Some example embodiments will be described with reference to the accompanying figures, in which:

FIG. 1 schematically shows a system according to an example embodiment;

FIG. 2 shows a block diagram of an apparatus according to an example embodiment; and

FIGS. 3-4 show flow charts according to example embodiments

### DETAILED DESCRIPTION

In the following description, like reference signs denote like elements or steps.

Various embodiments of present disclosure provide mechanisms to control a virtual power plant (VPP) that comprises a plurality of spatially distributed energy storage (DES) devices. The DES devices may be individually owned resources of households or small and medium sized companies or other smaller scaler operators. Alternatively or additionally, the DES devices may be energy assets owned by the operator of the virtual power plant or otherwise centrally owned energy assets. The DES devices may be intended for emergency backup purposes, but this is not mandatory. In an example embodiment, the DES devices are backup batteries of a wireless communication network. In another example embodiment, the DES devices are battery units of households or battery units of buildings. In an example embodiment, the DES devices are co-located with an energy production unit. As an alternative non-limiting example, the DES devices may be intended for storing energy from renewable sources such as solar panels and/or wind generators or even from fuel cell or other type of fuel-operated genset. Yet another additional or alternative intended use of the DES devices is optimization of self-consumption. The DES device may be a hybrid system using multiple energy sources.

In general, the DES devices in this disclosure refer to storage devices that are able to handle regular charge and discharge cycles. For example, lithium-ion batteries are such devices. In more detail, one or more of the following battery technologies may be used: lithium-nickel-cobalt, NCA, lithium-iron-phosphate, LFP, lithium-nickel-manganese-cobalt, NMC, solid-state batteries, and flow batteries. The DES devices may have different properties with regard to price, durability, physical size and chemical wear depending for example on the battery technology and storage capacity.

In general, lithium-based batteries should not regularly exceed extreme low or high charge values. For example, state of charge below 5% or above 95% should be avoided. Such limitations should be taken into account in usage of the lithium-based batteries to avoid increased wear of the batteries.

One aim that is to achieve with presently disclosed solutions is optimization of usage of the virtual power plant for grid balancing. Grid balancing may be arranged for example using automatic Frequency Restoration Reserve, aFRR, or Frequency Containment Reserve, FCR, capacity market.

aFRR is a centralized automatically activated reserve. Its activation is based on a power change signal calculated on the base of the frequency deviation in the Nordic synchronized area. Its purpose is to return the frequency to the nominal value.

FCR is an active power reserve that is automatically controlled based on the frequency deviation. FCR may be Frequency Containment Reserve for Normal Operation, FCR-N, or Frequency Containment Reserve for Disturbances, FCR-D. Their purpose is to contain the frequency during normal operation and disturbances.

The frequency balancing may comprise up regulation and/or down regulation. Up regulation means increasing power production or decreasing consumption. Down regulation means decreasing power production or increasing consumption. The up regulation and down regulation may be symmetric or asymmetric.

When the operator of the virtual power plant wants to participate in the grid balancing, bids need to be submitted to the reserve market in advance, e.g. the day before (in Finland by 7.30 CET the previous day). The bidding is based on some predefined plan and forecast of operating context during the bidding period. Even if bid is submitted, it is not necessarily accepted. Further, even if the bid is accepted, it is uncertain how the offered energy resource is activated. Possible activation hours are known, but actual activation depends on real time electricity consumption and possibly other factors. There are stochastic things that just happen and therefore the offered energy resource is not necessarily used as planned. Further, there may be variation in local energy source or backup battery needs. For this reason, the state of charge (SoC) levels in the DES devices may be different from the assumed SoC levels. Nevertheless, the operator of the VPP should be able to guarantee availability of the offered energy resource. For this reason, there is a need for real time monitoring and adjustment of operation of the VPP in order to optimize operation of the VPP.

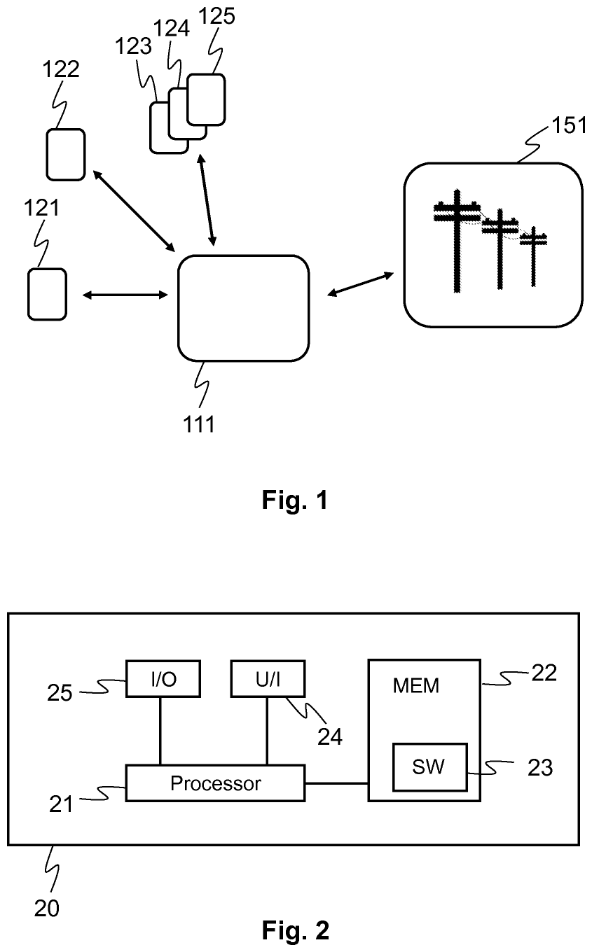

FIG. 1 schematically shows an example scenario according to an embodiment. The scenario shows a pool of DES devices 121-125. The DES devices 121-125 may be located at different geographical locations, but equally there may be plurality of DES devices at the same location. FIG. 1 shows the DES devices 123-125 at the same location and DES devices 121 and 122 individually at different locations. It is to be noted that this is only a non-limiting illustrative example and in practical implementations many different setups are possible. The DES devices may be intended for emergency backup purposes, but this is not mandatory. In an example embodiment, the DES devices are backup batteries of a wireless communication network. In another example embodiment, the DES devices are battery units of households or battery units of buildings. In an example embodiment, the DES devices are co-located with an energy production unit, such as solar or wind farm.

Further, the scenario shows a control system 111. The control system 111 and the DES devices 121-125 form a DES system that may operate as a virtual power plant. Still further, FIG. 1 shows an electric grid 151.

The control system 111 is configured to implement at least some example embodiments of present disclosure to control the virtual power plant. For this purpose, the control system 111 is operable to interact with the DES devices 121-125 or equipment associated thereto. Additionally, the control system 111 is operable to interact with the electric grid 151 or equipment associated thereto to coordinate participation in grid balancing and/or intraday trading market.

The operator of the virtual power plant may receive compensation based on the frequency balancing carried out for the electric grid. The compensation may depend on actual activation of frequency balancing and/or on reserving capacity for the possible frequency balancing needs.

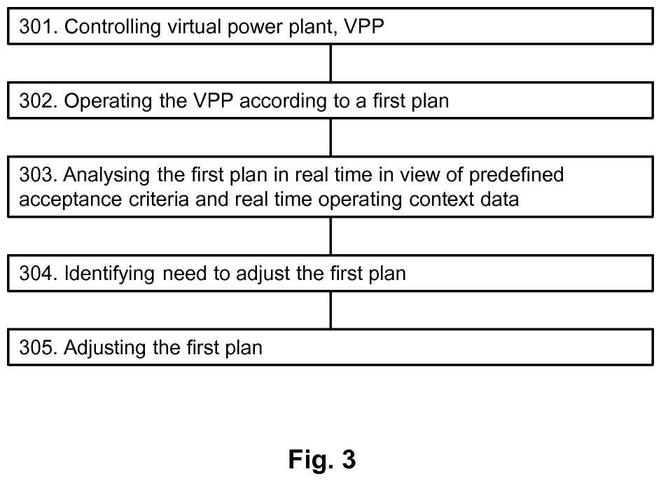

FIG. 2 shows a block diagram of an apparatus 20 according to an embodiment. The apparatus 20 is for example a general purpose computer, cloud computing environment or some other electronic data processing apparatus. The apparatus 20 can be used for implementing at least some embodiments of the invention. That is, with suitable configuration the apparatus 20 is suited for operating for example as the control system 111 of FIG. 1.

The apparatus 20 comprises a communication interface 25; a processor 21; a user interface 24; and a memory 22. The apparatus 20 further comprises software 23 stored in the memory 22 and operable to be loaded into and executed in the processor 21. The software 23 may comprise one or more software modules and can be in the form of a computer program product.

The processor 21 may comprise a central processing unit (CPU), a microprocessor, a digital signal processor (DSP), a graphics processing unit, or the like. FIG. 2 shows one processor 21, but the apparatus 20 may comprise a plurality of processors.

The user interface 24 is configured for providing interaction with a user of the apparatus. Additionally or alternatively, the user interaction may be implemented through the communication interface 25. The user interface 24 may comprise a circuitry for receiving input from a user of the apparatus 20, e.g., via a keyboard, graphical user interface shown on the display of the apparatus 20, speech recognition circuitry, or an accessory device, such as a headset, and for providing output to the user via, e.g., a graphical user interface or a loudspeaker.

The memory 22 may comprise for example a non-volatile or a volatile memory, such as a read-only memory (ROM), a programmable read-only memory (PROM), erasable programmable read-only memory (EPROM), a random-access memory (RAM), a flash memory, a data disk, an optical storage, a magnetic storage, a smart card, or the like. The apparatus 20 may comprise a plurality of memories. The memory 22 may serve the sole purpose of storing data or be constructed as a part of an apparatus 20 serving other purposes, such as processing data.

The communication interface 25 may comprise communication modules that implement data transmission to and from the apparatus 20. The communication modules may comprise a wireless or a wired interface module(s) or both. The wireless interface may comprise such as a WLAN, Bluetooth, infrared (IR), radio frequency identification (RF ID), GSM/GPRS, CDMA, WCDMA, LTE (Long Term Evolution) or 5G radio module. The wired interface may comprise such as Ethernet or universal serial bus (USB), for example. The communication interface 25 may support one or more different communication technologies. The apparatus 20 may additionally or alternatively comprise more than one of the communication interfaces 25.

A skilled person appreciates that in addition to the elements shown in FIG. 2, the apparatus 20 may comprise other elements, such as displays, as well as additional circuitry such as memory chips, application-specific integrated circuits (ASIC), other processing circuitry for specific purposes and the like.

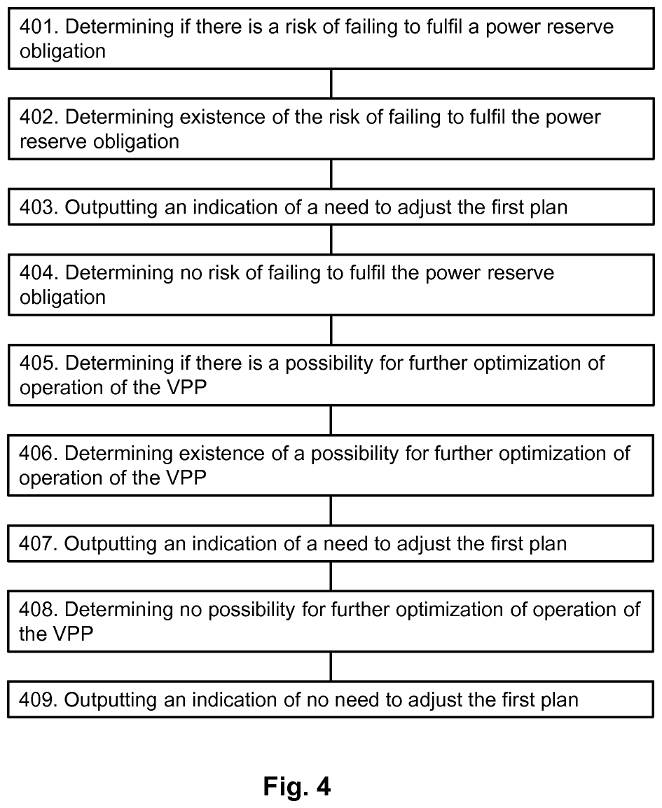

FIGS. 3-4 show flow charts related to example embodiments. FIGS. 3-4 illustrate processes comprising various possible steps including some optional steps while also further steps can be included and/or some of the steps can be performed more than once. The processes may be implemented in the control system 111 of FIG. 1 and/or in the apparatus 20 of FIG. 2. The processes are implemented in a computer program code and does not require human interaction unless otherwise expressly stated. It is to be noted that the processes may however provide output that may be further processed by humans and/or the processes may require user input to start.

The process of FIG. 3 comprises the following steps:
301: A virtual power plant, VPP, is controlled. The VPP comprises a plurality of spatially distributed energy storage, DES, devices, such as the DES devices of FIG. 1. The purpose of the VPP is to participate in balancing of an electric grid.
302: The virtual power plant is operated according to a first plan. The first plan provides a pre-planned schedule for charging or discharging the DES devices over a first time period to fulfil a power reserve obligation. The power reserve obligation is a balancing obligation towards the electric grid and obligation depends on a bid submitted to a reserve market. The first plan may further depend on local energy source need. The first time period may be for example one day or some other time period.

The first plan may be based on one or more forecasts that are made beforehand (before the first time period). One of the forecasts may concern local energy need, i.e. how much energy is likely needed from the DES device for the primary local purpose. Such forecast may be based on history data of local energy need. Another forecast may relate to state of charge (SoC) of the DES devices. Also this may be based on history data. Yet another forecast may relate to reserve markets and include for example predicted reserve market price levels and predicted electricity prices. These may be obtained from Transmission System Operators or operators of electric grid or elsewhere. Still further the first plan may be based on facts known about operation of the overall system during the first time period. E.g. spot price levels of the first time period may be facts that are known when the first plan is made.

Based on the datapoints and forecasts, the operator of the virtual power plant may place a bid on the reserve market. The bid may be automatically or manually determined.

The first plan may then be determined based on acceptance of the bid and the power reserve obligation of the accepted bid.

The pre-planned first plan is then used for scheduling charging or discharging the DES devices during the first time period. Ideally, the charging and discharging would take place as planned, but in real world this is not the case as discussed earlier in this document.
303: The first plan is analyzed in real time during the first time period. The analysis is performed in view of predefined acceptance criteria and real time operating context data. Further, the analyzing may be performed in view of fulfilling a local energy source need.

The analysis is performed for example by comparing real time SoC of the DES devices with assumed SoC that was used as a basis for the first plan. That is, current situation is compared with the first plan.

In an embodiment, the acceptance criteria defines one or more of: minimizing risk of failing to fulfil the power reserve obligation, minimizing risk of failing to fulfil the a local energy source need, and identifying a possibility for further optimization of operation of the virtual power plant.

The real time operating context data provides more accurate or up-to-date information about actual operating context compared to the data that is available beforehand when determining the first plan. In an embodiment, the real time operating context data comprises one or more of: DES infrastructure data, information about local energy source need, information about power reserve activations, information about electricity pricing. The DES infrastructure data may include one or more of the following: power consumption, capacity, wear, and physical properties of the DES devices of the virtual power plant. However, also further information may be included in the DES infrastructure data: whether the DES devices are located indoors or outdoors, temperature of the operating environment of the DES devices, geographical location of the DES devices, reliability of the DES devices, priority order of the DES devices. Such further information may be real time data or the information may be static information pre-stored into a database or the like.

In the context of this disclosure, the real time data is to be understood in relation to speed of change of that specific data. Real time may be considered as referring to currently valid data. For some relatively slowly changing data “real time” can be update frequency of minutes (or more), for faster changing data seconds or even less (in extreme cases). If the data does not change every minute, there is no need to update the data in terms of seconds to always have accurate real time data.
304: A need to adjust the first plan is identified on the basis of the analysis. There may be various factors that result in identifying a need to adjust the plan to achieve improved operation of the virtual power plant. For example, risk of failing to fulfil the power reserve obligation may be an indicator of a need to adjust the first plan. Additionally or alternatively, a possibility for further optimization of operation of the virtual power plant may be an indicator of a need to adjust the first plan. Some examples are discussed in detail later in this document.
305: The first plan is adjusted in real time according to the identified need.

In an embodiment, adjusting the first plan comprises selecting an adjustment mechanism from a pool of adjustment mechanisms. The pool comprises for example one or more of: adjusting staggering of the DES devices, adjusting charging of the DES devices, adjusting usage of energy stored in the DES devices, participating in intraday trading market, transferring the power reserve obligation to a different entity, minimizing battery wear. Further some other adjustment mechanisms may be used.

Staggering herein refers to method of using energy stored in backup battery as an energy source in normal operating conditions. This may be done e.g. during time periods when electricity is expensive and the backup battery may be recharged during time periods when the electricity is cheaper. Staggering could be referred to as load shifting, too.

The adjustment mechanisms of the pool may be arranged in order of preference. For example, if there is a risk of failing to fulfil the power reserve obligation, the first option may be adjusting staggering of the DES devices, the second option may be adjusting charging of the DES devices or adjusting usage of energy stored in the DES devices, the third option may be participating in intraday trading market, and the fourth option may be transferring the power reserve obligation to a different entity. For example, if there is a possibility for further optimization of operation of the virtual power plant, the first option may be adjusting staggering of the DES devices, the second option may be adjusting charging of the DES devices or adjusting usage of energy stored in the DES devices.

More detailed examples of adjustment mechanisms are discussed later in this document.

In an embodiment, the analysis of step 303 is performed for a subperiod of the first time period. The subperiod may be for example 1 hour or some other period. Then it is identified or analyzed whether there is a need to adjust the first plan over the subperiod on the basis of the analysis and the first plan is adjusted accordingly. Then the process continues to analyzing the following subperiod of the first time period, if any.

The process of FIG. 4 provides further example details of analyzing the first plan and comprises the following steps:
401: It is determined if there is a risk of failing to fulfil the power reserve obligation of the first plan.
402, 403: In case it is determined that a risk of failing to fulfil the power reserve obligation exists, an indication of a need to adjust the first plan is output in step 403. At least in some embodiments, fulfilling the power reserve obligation is the primary target.
404, 405. In case it is determined that there is no risk of failing to fulfil the power reserve obligation, it is determining if there is a possibility for further optimization of operation of the virtual power plant. It is checked e.g. if there is excess energy than may be used for additional optimization e.g. by adding staggering or participating in intraday trading market. In this way, the DES devices may be used more efficiently, if likelihood of being able to fulfil the power reserve obligation is high.
406, 407: In case it is determined that there a possibility for further optimization of operation of the virtual power plant exists, an indication of a need to adjust the first plan is output in step 407.
408, 409: In case it is determined that there is no possibility for further optimization of operation of the virtual power plant, an indication of no need to adjust the first plan may be output in step 409.

In the following some example cases are discussed:
1) The process identifies a risk of failing the power reserve obligation in up direction. The following is performed:
It is checked if there is planned staggering in the nearest timeslots.
   If yes, staggering is removed from some timeslots to have more energy available for the power reserve obligation.
   If no, it is checked if it is possible to charge the battery in some near timeslot (free of power reserve obligation).
      If no, it is checked if it is possible to modify power levels of the DES site. That is, if there is no power reserve activation right now, is it possible to charge the batteries and handle the changed power level also if the activation starts. If so, the power levels are adjusted to improve the situation.
2) There is a risk of failing the reserve obligation in down direction. The following is performed:
It is checked if there is planned staggering in the nearest timeslots.
   If no, staggering is added to some timeslots to have more room for energy.
   If yes, it is checked if it is possible to adjust the power levels of the DES site so that there is some battery usage also in the aFRR time slots when activation signal is not on.

In the following some further example cases are discussed:
1) Adjusting staggering of the DES devices.
In an example case, there were planned down regulations before the present time 13:00 that were not activated to the expected level. There was also planned staggering for the hour 13:00-14:00. Then the staggering action from hour 13:00-14:00 was removed and this lead to less battery usage for that hour to compensate the missing down regulation.
In an example case, there were planned up regulations before the present time 13:00 that were not activated to the expected level. There was no planned staggering for the hour 13:00-14:00. Then a staggering action was added to hour 13:00-14:00 and this lead to higher battery usage for that hour. This was possible since the up regulation did not take as much energy as expected.
In an example case, “free” hours are intentionally scheduled to the staggering plan in order to have more freedom for power reserve activations and vice-versa.
In an example case, if electricity price is high, it is checked if there are staggering free time slots where staggering could be added.
   It needs to be evaluated how much staggering can be added, whilst maintaining the risk of failing the power reserve obligation in up direction sufficiently low.
   If there are time slots free of staggering but with power reserve obligation, it needs to be evaluated if the power levels can be adjusted so that the cost of bought energy is minimized but it is still possible to deliver the power reserve obligations.
2) Adjusting charging of the DES devices and adjusting usage of energy stored in the DES devices.
In an example case, there is insufficient energy at time 15:00. To resolve this, additional charging can be done between 15:00-16:00 leading to higher energy level at 16:00.
In an example case, there is excess energy at time 15:00. Then additional discharging using inverters can be done between 15:00-16:00 leading to lower energy level at 16:00.
In an example case, if electricity price is low, it is checked if there are time slots without planned charging.
   It needs to be evaluated how much charging can be added, whilst maintaining the risk of failing reserve obligation in down direction sufficiently low.
3) Participating in intraday trading market.
In an example case, there is insufficient energy at time 15:00. To resolve this, energy is bought from intraday-market between 15:00-16:00 leading to higher energy level at 16:00.
In an example case, there is an abundance of energy at time 15:00. Then energy is sold in intraday-market between 15:00-16:00 leading to lower energy level at 16:00.
4) Transferring the power reserve obligation to a different entity.
By an ACER decision the power reserve provider is allowed to transfer the obligation until 1 hour before the scheduled hour.
In an example case, the energy level is very low at time 13:00 and it is very probable that it is not possible to deliver required energy between 15:00-16:00. To resolve this, the power reserve obligation from that hour is transferred to another provider.
In an example case, there is no planned down regulation for hour between 16:00-17:00 and energy level is low at current time 14:00. Then a power reserve obligation for down regulation is obtained for the hour 16:00-17:00 to increase the energy level if such obligation is available.
5) Minimizing battery wear.
SoC levels of the DES devices are controlled by (additional) discharging and charging actions so that very low or very high SoC is avoided.

Yet further example cases are discussed in the following:
In an example case, we have bid aFRR down for 2+0+2 MW for 3 consecutive hours, but we have only 3 MWh of empty capacity available in the batteries. According to the activation forecast, there is 5% chance of failing to deliver the last obligation. Then a staggering hour can be added in between the activations (zero hour in the above 2+0+2 MW example) or during lower bid hours in other example (e.g. the 1 MW hour in a 2+1+2 MW example allocation) to decrease the battery levels.
In an example case, it is likely that the aFRR obligations can be fulfilled with high probability and additionally there is further energy capacity available. However, the electricity price is very high during this time, so staggering can be added on batteries to decrease the energy cost.
In an example case, it is likely that the aFRR up obligations can be fulfilled with high probability but the SoC level of the batteries will decrease to levels that can cause wear on the battery chemistry. In this case charging can be added in between the activations (e.g. during zero hour in a 2+0+2 example up regulation obligations) to keep the SoC level in more optimal range.

When combining aFRR obligations with staggering, there is a need to consider how much and when staggering can be done whilst still avoiding risk of failing to fulfil the aFRR obligation.

In some embodiments, power levels are adjusted in order to improve performance on fulfilling the power reserve obligation. If the SoC levels of the DES devices are undesirable, it may be possible to adjust the power levels at the DES site by light charging or by partly turning the consumption onto batteries when the reserve activation signal is not on. The current power levels of the DES devices should meet the power levels of the power reserve activations. Thereby such power level adjustment may improve performance. E.g. if a battery is being charged when a down activation request is received, there is a need to adjust the charging power to be higher than in the case we no charging is done. In the case of too high SoC levels at the DES devices and consequent need to reduce the SoC levels, it is beneficial to do the adjustment according to the up regulation obligations and capabilities because the adjustment may affect capabilities of fulfilling the up regulation obligations. In the case of too low SoC levels at the DES devices and consequent need to increase SoC levels, it is beneficial to do the adjustment according to the down regulation obligations and capabilities because the adjustment may affect capabilities of fulfilling the down regulation obligations.

In the following some example cases of power level adjustments are discussed:
1) Too high SoC level, handling down regulation
Local consumption is (partly) switched to batteries to lower SoC levels.
If down regulation request is received, the current power level is adjusted by switching local consumption to the grid and by adding charging as much as is needed to meet the required activation power.
Example: Local consumption is 1 MW and the consumption is partly switched to batteries so that 0.5 MW is from the batteries and 0.5 MW is from the grid. Then, down activation request of 1 MW is received. Consequently, local consumption is switched completely to the grid and battery charging is increased by 0.5 MW in order to meet the required power change. Without the adjustment, there would be a need to charge by 1 MW.
2) Too high SoC level, handling up regulation
Local consumption is (partly) switched to batteries to lower SoC levels.
If up regulation request is received, the current power level is adjusted by switching local consumption completely to the batteries and by adding the use of inverters as much as is needed to meet the required activation power.
Example: Local consumption is 1 MW and the consumption is partly switched to batteries so that 0.5 MW is from the batteries and 0.5 MW is from the grid. Then, up activation request of 1 MW is received. Consequently, local consumption is switched completely to the batteries and, in addition, 0.5 MW is pushed through inverters to meet the requirement.
3) Too low SoC level, handling up regulation
Charging is started to increase the SoC level.
If up regulation request is received, the current power level is adjusted by first stopping the charging and then switching the local consumption to batteries as much as is needed to meet the power requirement.
Example: Local consumption is 1 MW, and battery charging is started with 0.5 MW so that total power is 1.5 MW. Then, up activation request of 1 MW is received. Consequently, the charging is stopped and local consumption is switched to the batteries so that 0.5 MW is coming from the batteries. Without the adjustment, there would be a need to get 1 MW from the batteries.
4) Too low SoC level, handling down regulation
Charging is started to increase the SoC level.
If down regulation request is received, the current power level is adjusted by increasing charging as much as is needed to meet the power requirement.
Example: Local consumption is 1 MW, and battery charging is started with 0.5 MW so that total power is 1.5 MW. Then, down activation request of 1 MW is received. Consequently, the total consumption needs to be increased to 2.5 MW by increasing charging the batteries.

Without in any way limiting the scope, interpretation, or application of the appended claims, a technical effect of one or more of the example embodiments disclosed herein is improved control of a virtual power plant. Various embodiments provide virtual power plant control mechanisms to handle uncertainties of grid balancing market and real time activations energy resources. Still further, the control mechanisms may take into account local energy needs and local usage of the DES devices of the virtual power plant. In this way, various embodiments provide mechanisms that suit well for controlling DES devices that are at the same time needed for fulfilling local energy source needs e.g. in wireless communication networks or in households.

A further technical effect is that overall usage of DES devices may be optimized as sufficient local usage is ensured whilst using any excess energy for grid balancing in a controlled manner.

Any of the afore described methods, method steps, or combinations thereof, may be controlled or performed using hardware; software; firmware; or any combination thereof. The software and/or hardware may be local; distributed; centralised; virtualised; or any combination thereof. Moreover, any form of computing, including computational intelligence, may be used for controlling or performing any of the afore described methods, method steps, or combinations thereof. Computational intelligence may refer to, for example, any of artificial intelligence; neural networks; fuzzy logics; machine learning; genetic algorithms; evolutionary computation; or any combination thereof.

Various embodiments have been presented. It should be appreciated that in this document, words comprise; include; and contain are each used as open-ended expressions with no intended exclusivity.

The foregoing description has provided by way of non-limiting examples of particular implementations and embodiments a full and informative description of the best mode presently contemplated by the inventors for carrying out the invention. It is however clear to a person skilled in the art that the invention is not restricted to details of the embodiments presented in the foregoing, but that it can be implemented in other embodiments using equivalent means or in different combinations of embodiments without deviating from the characteristics of the invention.

Furthermore, some of the features of the afore-disclosed example embodiments may be used to advantage without the corresponding use of other features. As such, the foregoing description shall be considered as merely illustrative of the principles of the present invention, and not in limitation thereof. Hence, the scope of the invention is only restricted by the appended patent claims.

1. A computer implemented method for controlling a virtual power plant, VPP, comprising a plurality of spatially distributed energy storage, DES, devices, to participate in balancing of electric grid, the method comprising:
operating the virtual power plant according to a first plan, wherein the first plan provides a pre-planned schedule for charging or discharging the DES devices over a first time period to fulfil a power reserve obligation of the electric grid according to a bid submitted to a reserve market;
analysing the first plan in real time during the first time period, wherein the analysis is performed in view of predefined acceptance criteria and real time operating context data; and
identifying a need to adjust the first plan on the basis of the analysis and accordingly adjusting the first plan in real time during the first time period.

2. The method of claim 1, further comprising
performing the analysis for a subperiod of the first time period;
identifying a need to adjust the first plan over the subperiod on the basis of the analysis and accordingly adjusting the first plan over the subperiod; and
continuing to analyse the following subperiod of the first time period, if any.

3. The method of claim 1, wherein the acceptance criteria is configured to provide one or more of: minimizing risk of failing to fulfil the power reserve obligation, minimizing risk of failing to fulfil a local energy source need, and identifying a possibility for further optimization of operation of the virtual power plant.

4. The method of claim 1, wherein the analysing comprises:
responsive to determining existence of a risk of failing to fulfil the power reserve obligation or existence of a possibility for further optimization of operation of the virtual power plant, outputting an indication of a need to adjust the first plan.

5. The method of claim 1, wherein the analysing comprises:
determining if there is a risk of failing to fulfil the power reserve obligation;
responsive to determining existence of a risk of failing to fulfil the power reserve obligation, outputting an indication of a need to adjust the first plan;
responsive to determining no risk of failing to fulfil the power reserve obligation, determining if there is a possibility for further optimization of operation of the virtual power plant;
responsive to determining existence of a possibility for further optimization of operation of the virtual power plant, outputting an indication of a need to adjust the first plan;
responsive to determining no possibility for further optimization of operation of the virtual power plant, outputting an indication of no need to adjust the first plan.

6. The method of claim 4, wherein the analysing is performed in view of fulfilling a local energy source need.

7. The method of claim 1, wherein the operating context data comprises one or more of: DES infrastructure data, information about local energy source need, information about power reserve activations, information about electricity pricing.

8. The method of claim 7, wherein the DES infrastructure data comprises one or more of the following: power consumption, capacity, wear, and physical properties of the DES devices of the virtual power plant.

9. The method of claim 1, wherein adjusting the first plan comprises selecting an adjustment mechanism from a pool of adjustment mechanisms comprising one or more of: adjusting staggering of the DES devices, adjusting charging of the DES devices, adjusting usage of energy stored in the DES devices, participating in intraday trading market, transferring the power reserve obligation to a different entity, minimizing battery wear.

10. The method of claim 9, wherein the adjustment mechanisms of the pool are arranged in order of preference.

11. The method of claim 1, wherein one or more of the DES devices are co-located with an energy production unit.

12. The method of claim 1, wherein the DES devices comprise backup batteries of a wireless communication network, or battery units of households, or battery units of buildings.

13. (canceled)

14. An apparatus comprising a processor and a memory including computer program code, and wherein the memory and the computer program code are configured to, with the processor, cause the apparatus to perform the method of claim 1.

15. A non-transitory computer readable medium having a computer program comprising computer executable program code configured to cause an apparatus to perform the method of claim 1.
